(19) United States
(12) Patent Application Publication
(10) Pub. No.: US 2015/0145294 A1
(43) Pub. Date: May 28, 2015

(54) ADJUSTABLE CYCLE SEAT

(71) Applicant: Rase Components, LLC, Salisbury, MA (US)

(72) Inventor: Stanley F. Kench, III, Newburyport, MA (US)

(73) Assignee: Rase Components, LLC, Salisbury, MA (US)

(21) Appl. No.: 14/090,029

(22) Filed: Nov. 26, 2013

(51) Int. Cl. B62J 1/00

(52) U.S. Cl. CPC B62J 1/00
USPC 297/215.13

(57) ABSTRACT

An adjustable cycle seat includes a seat post configured as an I-beam with front and rear flanges and a web therebetween defining side channels. A sleeve about the post is attached to the cycle. At least one spring is interconnected between the post and the sleeve biasing the post upward. An actuatable locking mechanism releasable secures the post to the sleeve.

### FIELD OF THE INVENTION

The subject invention relates to adjustable cycle (e.g., bicycle) seats.

### BACKGROUND OF THE INVENTION

Conventional bicycle seats are raised and lowered via a clamp assembly releasably positioning the seat post with respect to a sleeve fixed to the bicycle frame.

For some applications, on-the-fly seat adjustment is desirable. For example, a mountain bike rider may want the seat higher while on gentle terrain but lower while traversing more challenging terrain. Accordingly, on-the-fly designs typically include a lever on the handle bar actuating a cable leading to a mechanism on the seat sleeve which allows the seat post to be adjusted relative to the sleeve. See, for example, U.S. Pat. Nos. 8,136,877 and 6,354,557 as well as U.S. published application no. 2012/0104810 all incorporated herein by this reference.

Some of these designs are not strong enough to meet the specifications of bicycle manufacturers. Mountain bikes, in particular, experience severe loads on the seat post. Also, some designs have cables which extend perpendicular to the seat sleeve resulting in possible irritation to the rider.

Gas spring designs, in turn, may result in limited seat post travel, add weight, and may pose reliability and/or maintainability concerns.

### SUMMARY OF THE INVENTION

In one aspect, a new adjustable seat is provided which is strong, light weight, and reliable.

Featured is an adjustable cycle seat comprising a post supporting a seat clamp and configured as an I-beam with front and rear flanges and a web therebetween defining side channels. A sleeve about the post is attached to the cycle. At least one spring is interconnected between the post and the sleeve biasing the post upward. An actuatable locking mechanism releasable secures the post to the sleeve.

The spring may reside in at least one or both side channels. Preferably, the locking mechanism interacts with the front flange to releasable lock the post to the sleeve. In one design, the locking mechanism includes a fork member engaging a spaced series of notches in the front flange. The fork member is moveably disposed in the sleeve. The fork member may be biased into engagement with the post. The locking mechanism may further include a cable mechanism for retracting the fork member. One cable mechanism includes a cable stop aligned with the sleeve and a wedge member for retracting the fork member disposed in a well in the fork member. In one design, at least one boss is attached to the sleeve and extends into a said side channel to prevent rotation of the post in the sleeve. There may be orifices in the web for stop members.

In another design, the locking mechanism includes a retractable pin engaging the web of the post.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic three dimensional front view of a prior art adjustable seat post and sleeve;

FIG. 2 is schematic three dimensional front view of an example of an adjustable seat mechanism in accordance with the subject invention;

FIG. 3 is an exploded view showing the primary components of the example of FIG. 2;

FIG. 4 is a schematic front view of the novel seat post of FIGS. 2 and 3;

FIG. 5 is a schematic three dimensional top view showing a portion of the seat post and sleeve assemblies;

FIG. 6 is a schematic three dimensional view showing the seat post and the fork member of the locking mechanism;

FIG. 7 is a view showing the primary components associated with the locking mechanism;

FIG. 8 is a schematic three dimensional view of the seat post now disposed in the bicycle frame and including a constant force spring for biasing this seat post upwards;

FIG. 9 is a schematic three dimensional side view of a prototype example of the invention showing the use of a different kind of spring;

FIG. 10 is a schematic three dimensional view showing an example of a seat post with an integral pumping subsystem piston mounted in a portion of the bicycle seat frame configured as a cylinder for the post piston;

FIG. 11 is a schematic view of another version where the pump cylinder is a liner set in the bicycle frame member;

FIG. 12 is a partial cross-section view showing the air path; and

FIGS. 13A-13B are schematic views showing a side locking pin design in accordance with examples of the invention.

The subject invention, however, in other embodiments, need not achieve all these objectives and the claims hereof should not be limited to structures or methods capable of achieving these objectives.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

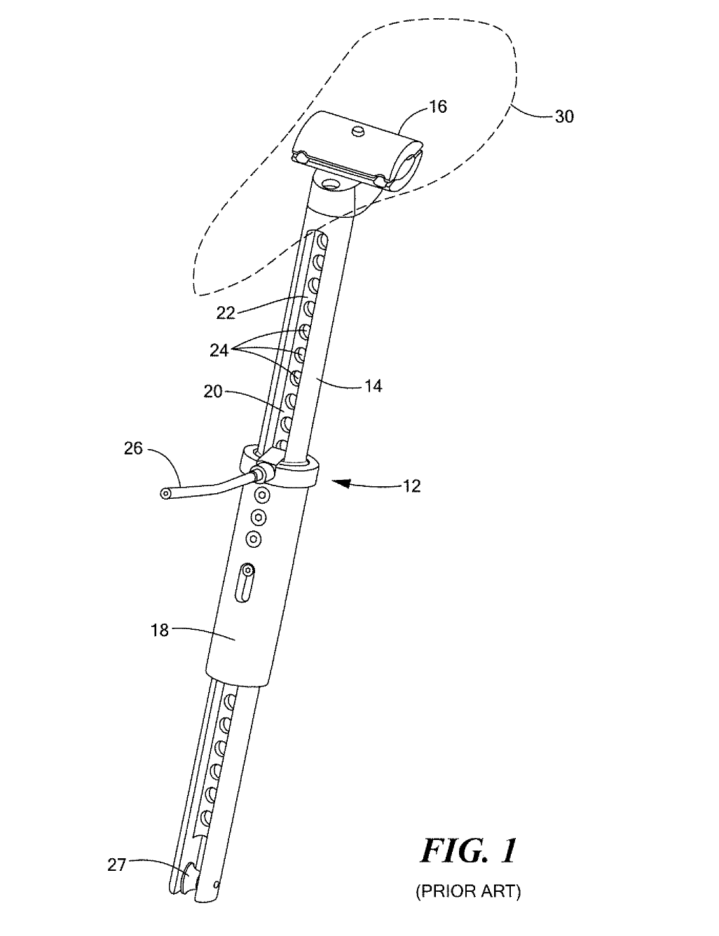

FIG. 1 shows prior art adjustable seat mechanism 12 with post 14 supporting seat clamp 16. Post 14 is adjustable with respect to sleeve 18. Post 14 has front channel 20 (and a rear lengthwise hole (not shown)). Inner wall 22 has a number of detents 24.

Cable 26 is activated by a handle bar mounted lever to drive a pin extending through sleeve 18 into and to retract it from one of the detents 24. A spring, not shown, extends from the top of the rear hole, around pulley 27, and into front channel 20 and biases the post upwards.

Because front channel 20 and/or the lengthwise hole weakens post 14 in the direction of the main load experienced by the post (the seat is shown in relief at 30), this design may not pass the specifications of bicycle manufacturers.

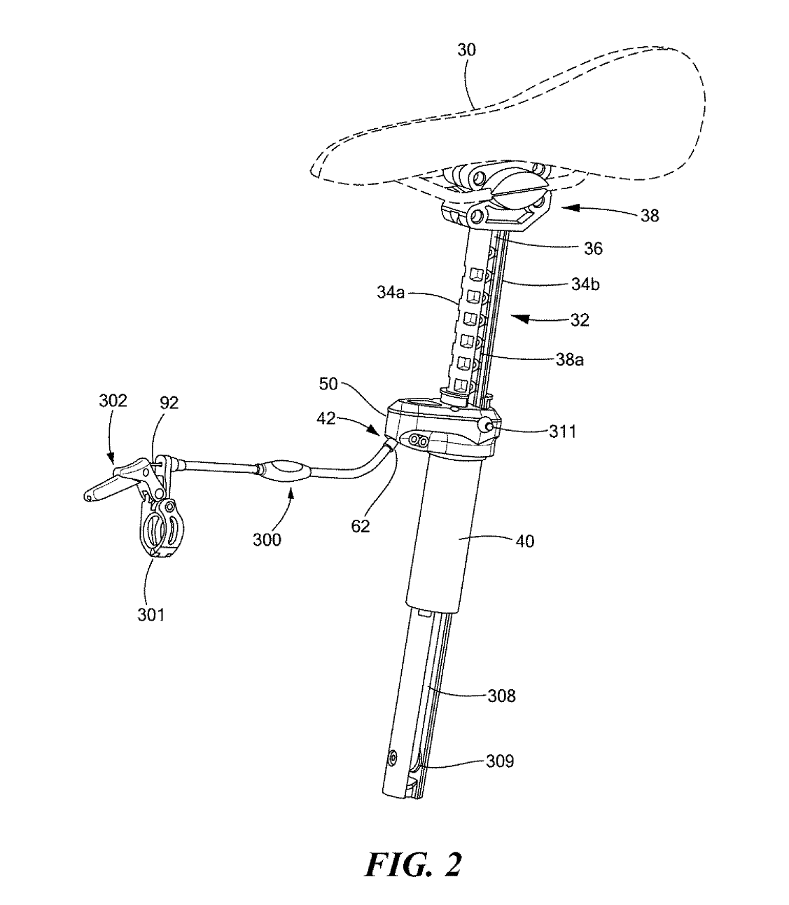

In the new design, shown by way of example in FIG. 2, the seat post 32 is configured as or like an I-beam with curved front 34a and curved rear 34b flanges connected via web 36 defining opposing side channels (side channel 38a is shown). Post 32 supports seat clamp 38 for seat 30. This configuration for post 32 results in a higher cross sectional moment of inertia and thus higher strength for repeated loads experienced by post 32 which is angled rearwardly with respect to the bike frame.

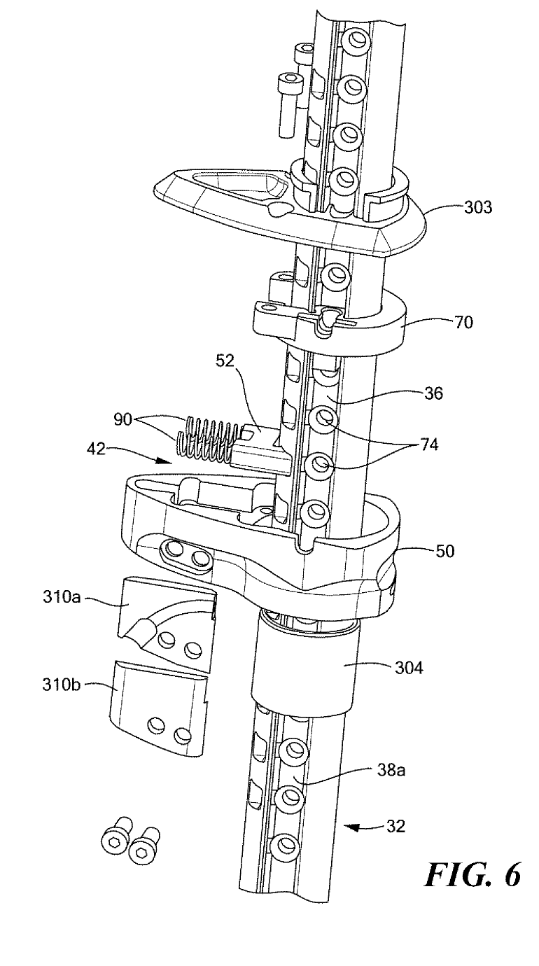

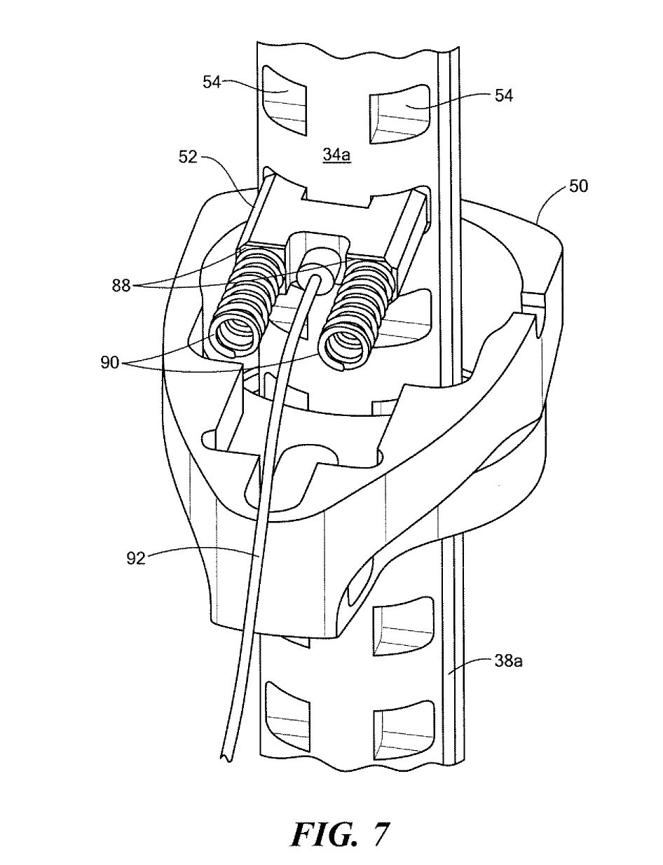

Sleeve 40 is attached to the bike frame and post 32 is moveable within sleeve 40. Locking mechanism 42, FIGS. 2-3 and FIGS. 5-7 is associated with sleeve housing portion 50 and releasably secures the post in one of a number of positions relative to sleeve 40. A spring mechanism 308 biases post 32 upwards. The spring or springs preferably reside in the side channels (e.g., side channel 38a) as discussed below and extends around pulley 309 at the bottom of post 32 up to sleeve 40 where it is fixed to the sleeve via pin 311.

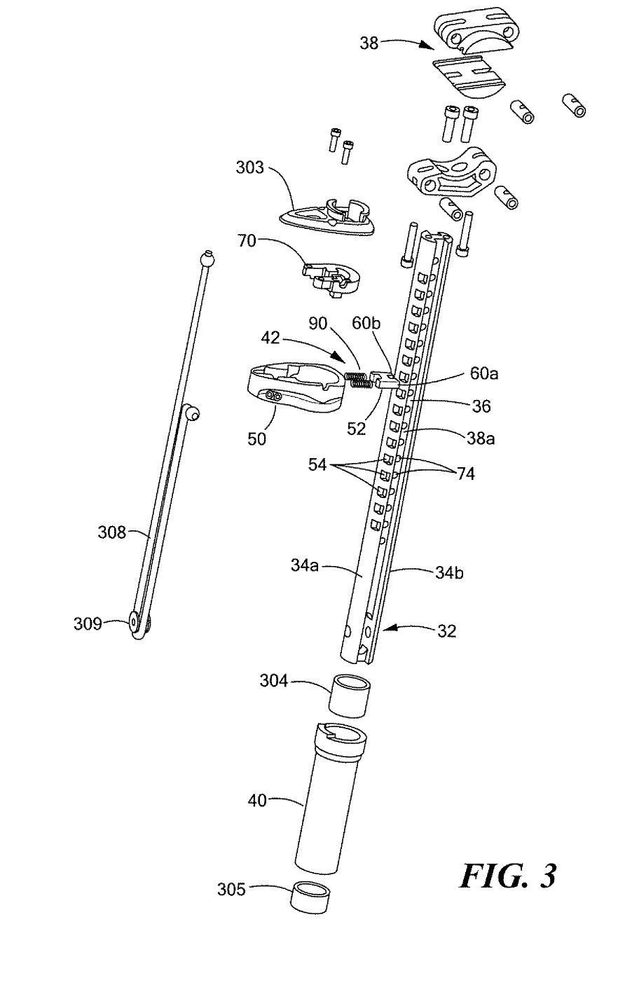

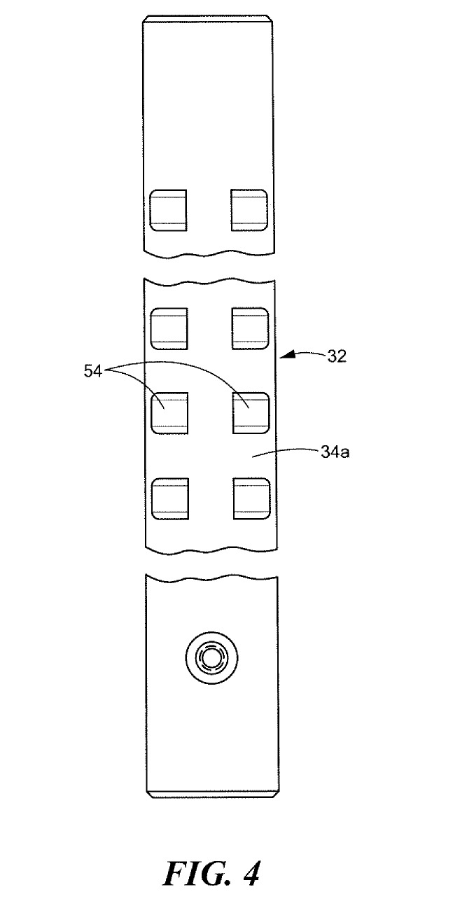

As shown in FIG. 3 where sleeve housing portion 50 is shown separately from sleeve 40, locking mechanism fork member 52 interacts with front flange 34a and the spaced series of notches 54 therein (e.g., a series of pairs of notches, each pair at a different elevation on post 32, FIG. 4). The spaced prongs 60a and 60b of fork 52 releasably engage these notches. Fork 52 is preferably movably disposed in housing 50 of sleeve 40 and biased into engagement with post 32 by one or more springs 90. A cable 92, FIG. 2 extending from cable stop 62 is connected to a lever 302 mounted to the bike handle bars and retracts fork 52, FIG. 3 to adjust seat post 32 up and down relative to sleeve 40. As shown, it is preferred that cable stop 62, FIG. 2 be angled substantially downward to minimize interference with the cable. Other means for activating the locking mechanism to adjust the seat are possible.

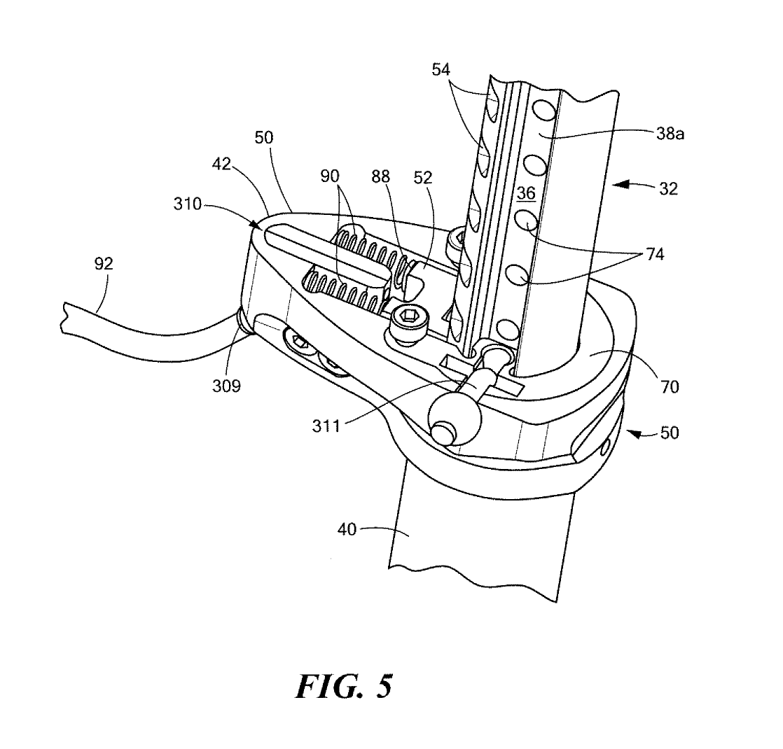

In this particular design, boss 70, FIGS. 3 and 5 are attached to sleeve 40 housing 50 and extends into side channel 38a to prevent rotation of the post with respect to the sleeve. Orifices 74 in web 36 allow for the inclusion of stop members to limit the travel of seat post 32 to suit the rider's preference.

Other release mechanisms are possible but it is preferred that they interact with the front (and/or rear) flange of the seat post. By not associating the release mechanism with the side channels (or the web member), there is no interference with the post spring or springs which can now be made longer to increase the travel of the seat post. But, these are preferred designs only.

FIGS. 5-7 show housing 50 supporting locking mechanism 42. The rear 88 of fork member 52 is biased forward so the fork members engage post 32. Springs 90 push on the rear of fork member 52. The cable 92, FIG. 2 pulls fork member 52 rearward out of engagement of post 32 allowing it to move up and down for seat adjustment. Guide blocks 310a and 310b define the cable path in the preferred, downward direction. Releasing the cable forces fork member 52 into engagement with the post.

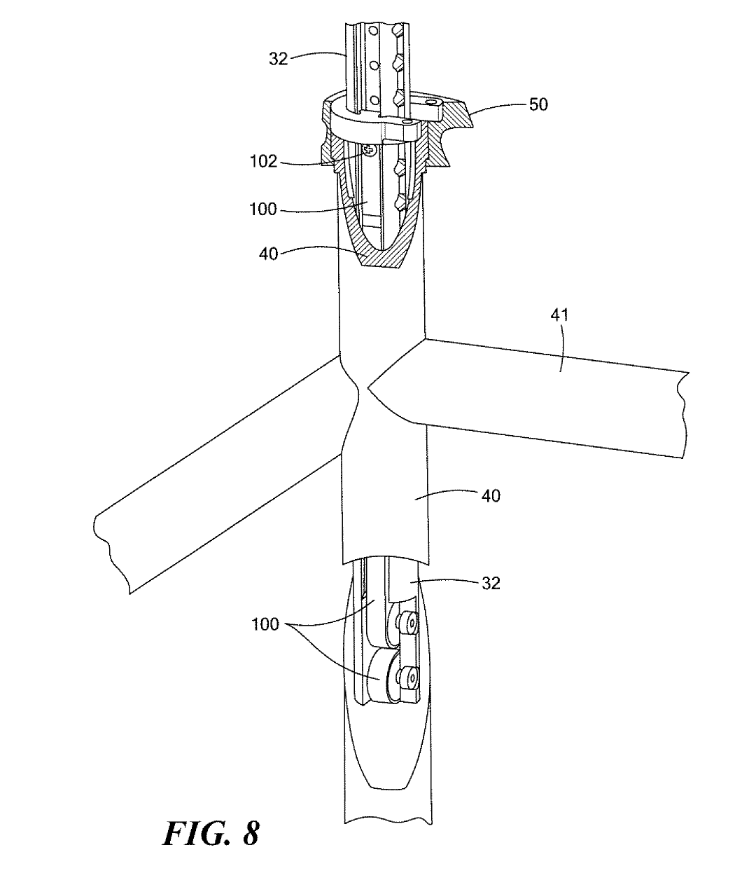

FIG. 8 shows one embodiment in which a constant force spring 100 on a drum or in a pocket in the bottom of post 32 and anchored on one end 102 to the sleeve. This biases post 32 upward in sleeve 40 of bike frame 41.

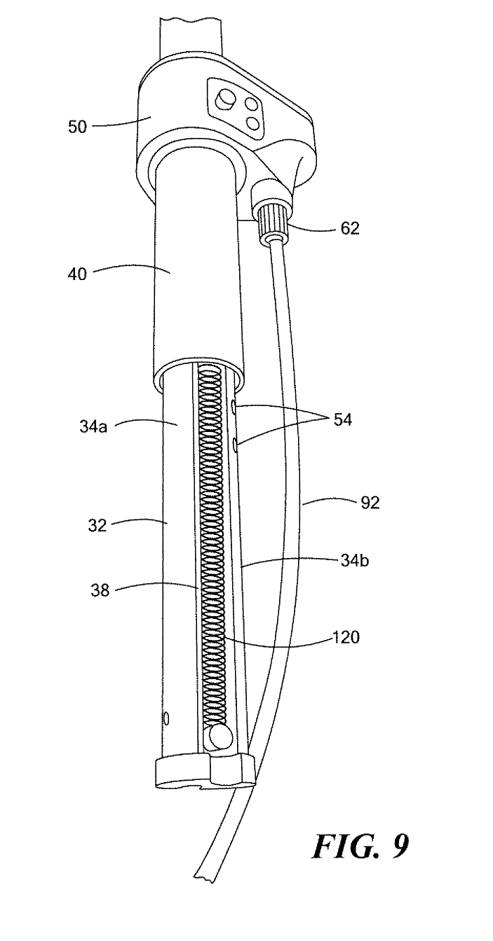

In FIG. 9, spring 120 is attached at the bottom of post 32, resides in channel 38b, and is anchored to sleeve 40. When the post is pushed down, the spring extends. Another spring could reside in the opposing I-beam member channel. Or, a spring or elastic cord (shock cord or bungee) could wrap around a pulley at the bottom of post 32 and anchor to opposite sides of the sleeve. This allows extra length for the spring to accommodate long travel wells into the post length.

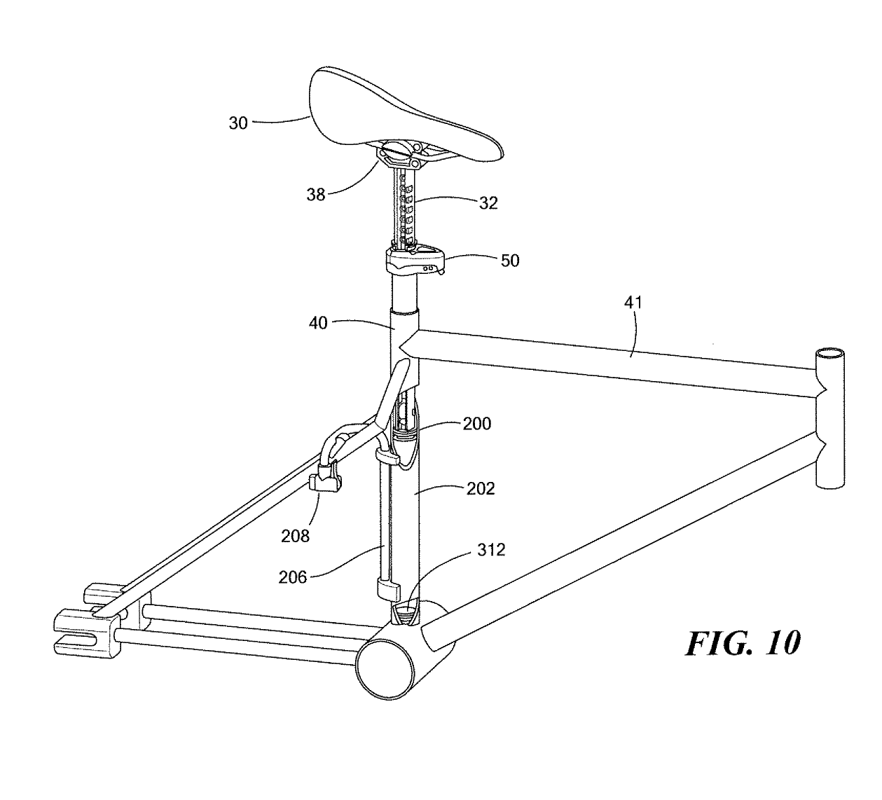

FIG. 10 shows a version with a piston 200 on the bottom of post 32. Then, the bike frame member 202, acts as a cylinder with an air outlet connected to hose 206 with tire filling nozzle 208 for pumping air into a bike tire by raising seat 30 up and down in a pumping action. Plug 312 seals the bottom of member 202.

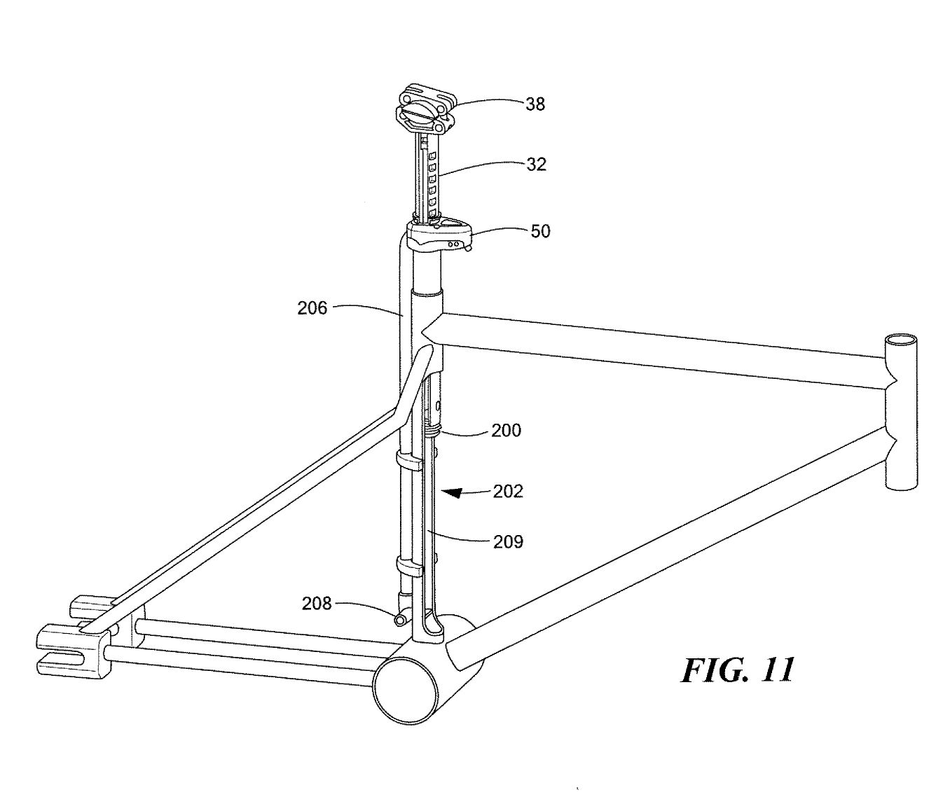

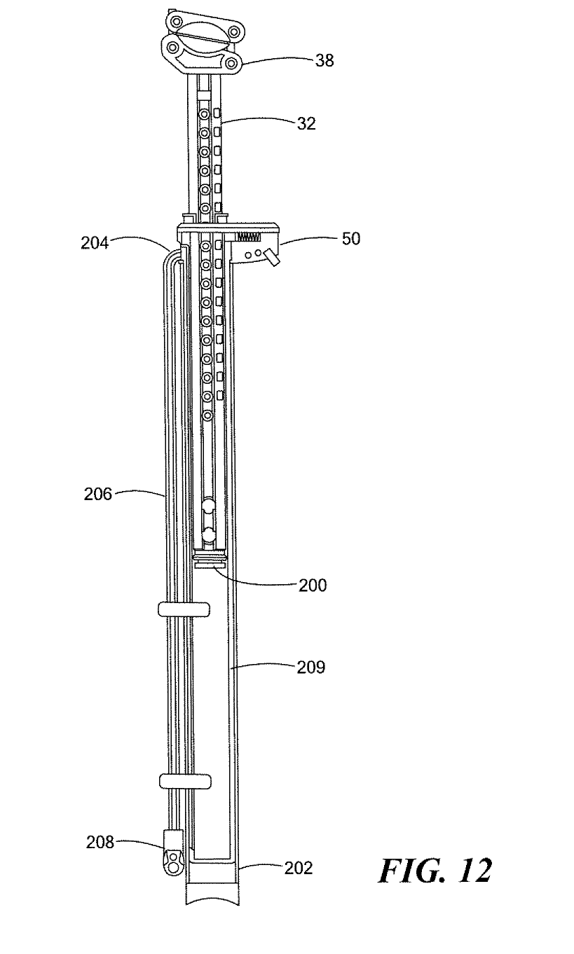

Alternatively, a liner 209 can be placed in frame member 202, FIGS. 11-12. The air exit is now through a space between the liner and the frame member.

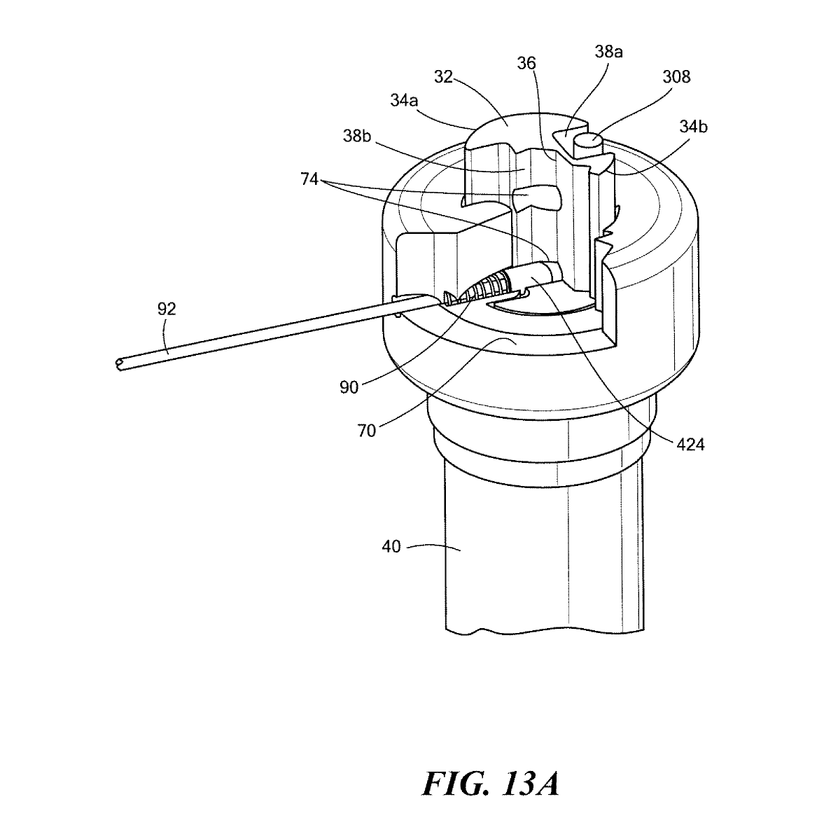

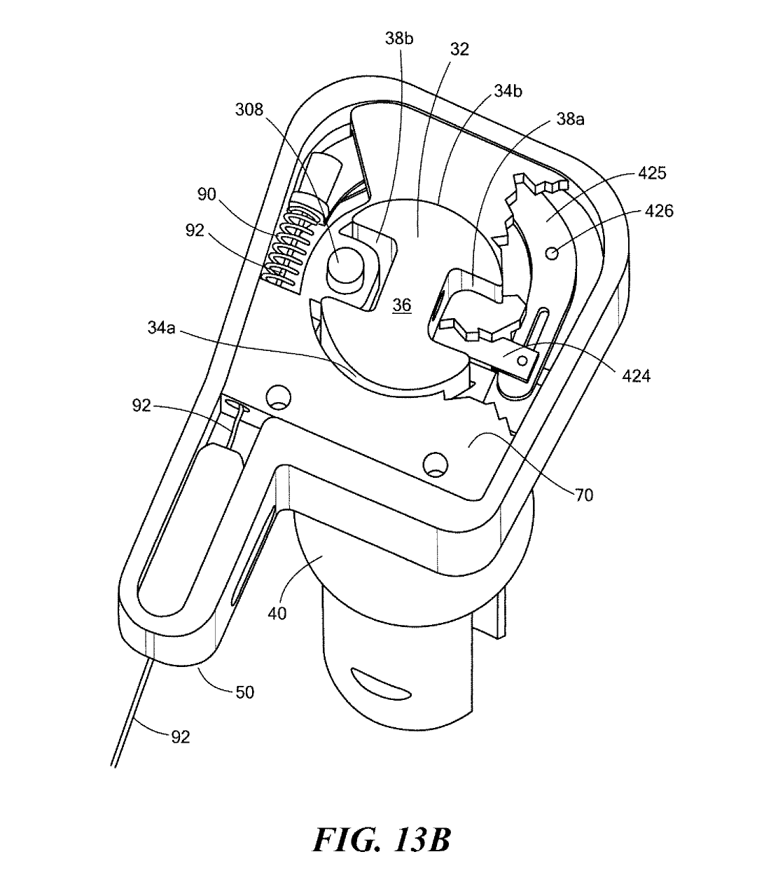

In FIG. 13A, the post 32 has front flange 34a and rear flange 34b and side channels 38a and 38b. Here pin 424 extends through sleeve 40 and into one of a number of orifices 74 in the web 36 between the side channels to releasably lock sleeve 40 with respect to post 32. Cable 92 can be used to pull pin 424 out of an orifice 74 in web 36 for adjustment of post 32. Spring 90 biases pin 424 into a locked position shown in FIG. 13A.

In FIG. 13B, cable 92 now exits the front of the bike seat post assembly. Pulling on cable 92 rotates arm 425 about pin 426 compressing spring 90 and retracts pin 424 allowing the height of the seat to be adjusted. Again, pin 424 interacts with orifices in web 36.

Thus, although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. An adjustable cycle seat comprising:
a post supporting a seat clamp and configured as an I-beam with front and rear flanges and a web therebetween defining side channels;
a sleeve about the post attached to the cycle;
at least one spring interconnected between the post and the sleeve biasing the post upward; and
an actuatable locking mechanism releasably securing the post to the sleeve.

2. The adjustable cycle seat of claim 1 in which the spring resides in at least one said side channel.

3. The adjustable cycle seat of claim 1 in which the locking mechanism interacts with the front flange to releasably lock the post to the sleeve.

4. The adjustable cycle seat of claim 3 in which the locking mechanism includes a fork member engaging a spaced series of notches in the front flange.

5. The adjustable cycle seat of claim 4 in which the fork member is moveably disposed in the sleeve.

6. The adjustable cycle seat of claim 5 in which the fork member is biased into engagement with the post.

7. The adjustable cycle seat of claim 6 in which the releasable locking mechanism further includes a cable mechanism for retracting the fork member.

8. The adjustable cycle seat of claim 7 in which the cable mechanism includes a downwardly angled cable stop.

9. The adjustable cycle seat of claim 7 in which the cable mechanism includes a cable attached to the fork member.

10. The adjustable cycle seat of claim 9 in which the cable mechanism further includes cable guide members.

11. The adjustable cycle seat of claim 1 in which the locking mechanism interacts with the web.

12. The adjustable cycle seat of claim 11 in which the locking mechanism includes a retractable pin.

13. The adjustable cycle seat of claim 12 in which the locking mechanism includes a pivoting arm connected to the retractable pin.

14. The adjustable cycle seat of claim 1 further including at least one boss attached to the sleeve extending into a said side channel to prevent rotation of the post in the sleeve.

15. The adjustable cycle seat of claim 1 further including orifices in the web for stop members.

16. The adjustable cycle seat of claim 1 further including a pump subsystem.

17. The adjustable cycle seat of claim 16 in which the pump subsystem includes a piston on the post.

18. An adjustable cycle seat comprising:
a post supporting a seat clamp and configured as an I-beam with front and rear flanges and a web therebetween defining side channels;
a sleeve about the post attached to the cycle;
an actuatable locking mechanism interacting with post to releasably lock the post to the sleeve in different positions; and
a pump subsystem including a piston on the post.

19. The adjustable cycle seat of claim 18 further including at least one spring interconnected between the post and the sleeve biasing the post upwards.

20. The adjustable cycle seat of claim 18 in which the spring resides in at least one said side channel.

21. The adjustable cycle seat of claim 18 in which the locking mechanism includes a fork member engaging a spaced series of notches in the front flange.

22. The adjustable cycle seat of claim 18 in which the locking mechanism including a pin engaging the web.

23. The adjustable cycle seat of claim 18 further including at least one boss attached to the sleeve extending into a said side channel to prevent rotation of the post in the sleeve.
